(19) United States
(12) Patent Application Publication
(10) Pub. No.: US 2025/0110203 A1
(43) Pub. Date: Apr. 3, 2025

(54) Optical Linearization Technique

(71) Applicant: AyDeeKay LLC dba Indie Semiconductor, Aliso Viejo, CA (US)

(72) Inventor: Facundo Picco, Aliso Viejo, CA (US)

(73) Assignee: AyDeeKay LLC dba Indie Semiconductor, Aliso Viejo, CA (US)

(21) Appl. No.: 18/899,991

(22) Filed: Sep. 27, 2024

Related U.S. Application Data
(60) Provisional application No. 63/541,202, filed on Sep. 28, 2023.

(51) Int. Cl. G01S 7/02; G01S 7/35; G01S 13/524; G01S 17/36

(52) U.S. Cl. CPC G01S 7/023; G01S 7/356; G01S 13/5246; G01S 17/36

(57) ABSTRACT

An integrated circuit is described. This integrated circuit may include multiple stages. At a given time, the integrated circuit may be configured to use one or more of the stages in the processing of received signals associated with measurements in an environment. For example, a control circuit or control logic in the integrated circuit may configure the use of one or more of the stages in the integrated circuit. A first stage in the stages may perform coherent interference mitigation by correcting the received signals for a predicted complex signal associated with a spurious source. Moreover, a second stage in the stages may perform equalization of the received signals based at least in part on a target criterion. Furthermore, a third stage in the stages may combine different received signals (such as received signals associated with different measurements) and may detect one or more peaks in the received signals.

### CROSS REFERENCE TO RELATED APPLICATIONS

This application claims priority under 35 U.S.C. 119 (e) to U.S. Provisional Application Ser. No. 63/541,202, entitled “Interference Mitigation Engine,” by Facundo Picco, et al., filed on Sep. 28, 2023, the contents of which are herein incorporated by reference.

### FIELD

The present disclosure relates to techniques for mitigating interference associated with wireless and/or optical measurements. For example, the techniques may mitigate interference associated with radar or lidar.

### BACKGROUND

Wireless and optical measurements in an environment are often distorted by interference sources. However, it can be complicated and expensive to compensate or correct for different interference sources.

For example, radio detection and ranging (radar) uses electromagnetic waves or beams to measure the relative positions and/or velocities of one or more objects in an environment, such surrounding a vehicle. Because of the width of the electromagnetic waves or beams in radar, there is often a lot of clutter or unwanted echoes in radar measurements.

Similarly, light detection and ranging (lidar) uses optical pulses or continuous waves to measure relative positions and velocities of one or more objects in an environment. The narrow widths of the optical beams in lidar measurements can reduce the amount of clutter or transient signals in measurements. However, the use of higher carrier frequencies in lidar measurements typically increases the Doppler effect and results in a mixture of signals associated with relative positions and velocities.

### SUMMARY

Embodiments of an integrated circuit are described. This integrated circuit includes multiple stages. At a given time, the integrated circuit is configured to use one or more of the stages in the processing of received signals associated with measurements in an environment. For example, a control circuit or control logic in the integrated circuit configures the use of one or more of the stages in the integrated circuit. A first stage in the stages performs coherent interference mitigation by correcting the received signals for a predicted complex signal (such as an amplitude and a phase) associated with a spurious source. Moreover, a second stage in the stages performs equalization of the received signals based at least in part on a target criterion. Furthermore, a third stage in the stages combines different received signals (such as received signals associated with different measurements) and detects one or more peaks in the received signals.

For example, the predicted complex signal may include a predicted magnitude and a predicted phase associated with the spurious source over multiple frames in the measurements.

Moreover, the measurements may include lidar measurements and/or radar measurements.

Furthermore, correcting the received signals for the predicted complex signal may be performed in the frequency domain.

Additionally, the spurious signal may be associated with a reflection from a window or a housing. Therefore, the spurious signal may be located a short distance from a measurement device (such as a lidar measurement device) in or associated with the integrated circuit.

In some embodiments, the equalization may be performed in the frequency domain.

Note that the target criterion may include: a constant average energy in the frequency domain; a constant moment of a distribution (such as a median) of a magnitude square amplitude in the frequency domain; or a boosting of the magnitude square amplitude at frequencies greater than a predefined value (such as frequencies corresponding to a largest range from the integrated circuit).

Moreover, the target criterion may be based at least in part on a performance metric associated with peak detection. Alternatively or additionally, the target criterion may ensure a noise profile associated with the received signals has a desired (e.g., a predefined or predetermined) shape when the received signals correspond to an absence of returned signals during the measurements.

Furthermore, the received signals may correspond to optical signals having carrier frequencies that vary as a function of time using a predefined function (such as a sawtooth function, a triangle function, etc.). Therefore, the received signals may correspond to chirped optical signals.

In some embodiments, an order of the stages in the integrated circuit may be rearranged or different.

Note that the integrated circuit may include a transformation circuit that performs a Fourier Transform of the received signals (such as a Fast Fourier Transform or FFT) before the multiple stages.

Moreover, the operations performed by the integrated circuit may be performed in hardware and/or software. Note that the stages in the integrated circuit may operate independently of each other.

Furthermore, the third stage may combine a magnitude square or a logarithm of magnitude of the different measurements in the frequency domain. Note that the different measurements may use different electromagnetic transmit signals: in different channels or bands of frequencies and/or having different polarizations (e.g., to de-speckle the different measurements).

Additionally, the third stage may detect the one or more peaks in the received signals, e.g., using a constant false alarm rate (CFAR) estimation technique (such as cell-averaging CFAR). Note that CFAR is one type of detection technique that may be used in the present disclosure. Alternatively, or possibly in combination with CFAR, a fixed comparison threshold may be used for peak detection.

In some embodiments, the CFAR estimation technique may include determining a threshold corresponding to a noise level in the frequency domain. Moreover, the third stage may: detect the one or more peaks in the received signals based at least in part on a detection probability and a false-alarm rate; and/or estimate false alarms in the one or more peaks in the received signals. Note that the one or more peaks may be detected: using a local maximum detector; based at least in part on a number of the one or more peaks; and/or based at least in part on a comparison with the threshold.

Moreover, the third stage may block detection of a set of blocked out peaks in the received signals.

Furthermore, at least some of the operations in the multiple stages may be repeated for the different received signals.

Additionally, the third stage may reverse an equalization correction performed by the second stage in order to obtain a true energy of the received signals.

Another embodiment provides an electronic device that includes the integrated circuit.

Another embodiment provides a system that includes the integrated circuit.

Another embodiment provides a method for selectively performing processing of the received signals. This method includes at least some of the operations performed by the integrated circuit.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a block diagram illustrating a circuit diagram of a processing circuit for received signals according to some embodiments of the present disclosure.

FIG. 2 is a flow diagram illustrating an example of a method for selectively performing processing of received signals according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

An integrated circuit is described. This integrated circuit may include multiple stages. At a given time, the integrated circuit may be configured to use one or more of the stages in the processing of received signals associated with measurements in an environment. For example, a control circuit or control logic in the integrated circuit may configure the use of one or more of the stages in the integrated circuit. A first stage in the stages may perform coherent interference mitigation by correcting the received signals for a predicted complex signal associated with a spurious source. Moreover, a second stage in the stages may perform equalization of the received signals based at least in part on a target criterion. Furthermore, a third stage in the stages may combine different received signals (such as received signals associated with different measurements) and may detect one or more peaks in the received signals.

By selectively performing the processing, these circuit techniques may allow the integrated circuit to have improved performance. For example, the integrated circuit may be able to more accurately (e.g., with a reduced false-positive rate) detect peaks in the received signals and, thus, to determine the relative positions and velocities of one or more objects in the surrounding environment. Consequently, the circuit techniques may facilitate the increased use of the integrated circuit in a wide variety of systems, electronic devices and applications. For example, the integrated circuit may be used in semi-autonomous and/or autonomous or self-driving vehicles.

We now describe embodiments of the circuit techniques. These circuit techniques may be performed using one or more integrated circuits. The one or more integrated circuits may include some or all of the described components and associated functionality.

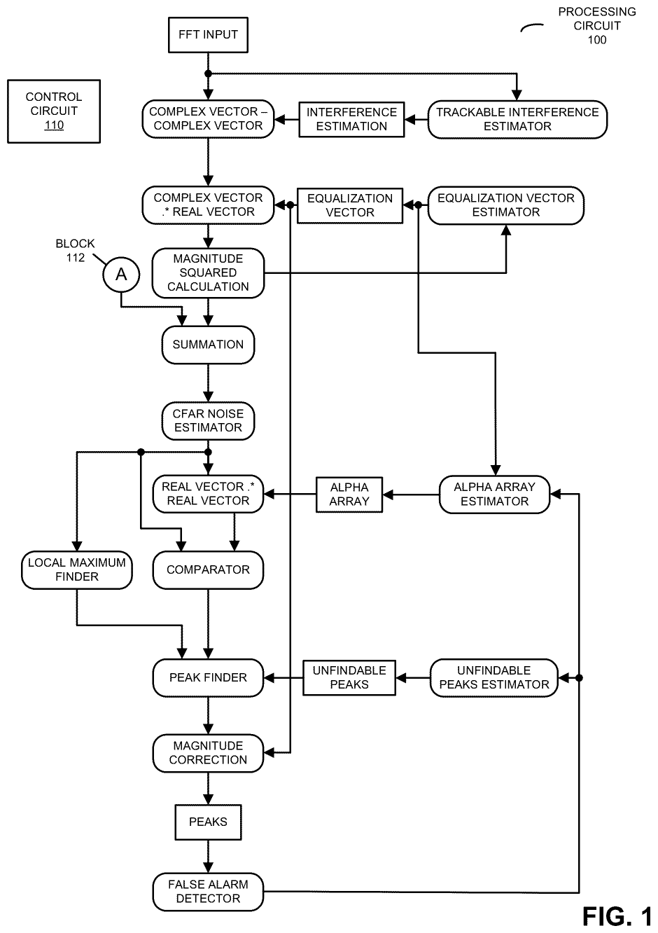

FIG. 1 presents a block diagram illustrating a circuit diagram of a processing circuit 100 for received signals, such as reflected signals in a measurement system that uses lidar and/or radar. During operation, a control circuit 110 in the processing circuit configures the use of one or more of the stages in processing circuit 100. Processing circuit 100 may provide an interference mitigation engine for received signals corresponding to or associated with lidar measurements and/or radar measurements. For example, the received signals may include frequency modulated continuous wave (FMCW) signals. However, in other embodiments, the received signals may include pulsed signals. In the discussion that follows, FMCW signals are used as an illustrative example.

The lidar measurements and/or the radar measurements may use a chirped signal in which the carrier frequency of the transmit signals (and, thus, the received signals) is varied as a function of time. For example, the carrier frequency may be varied linearly between a start carrier frequency and an end carrier frequency during a chirped frame. This predefined chirp pattern may be repeated one or more times in a chirped frame. Moreover, the predefined chirp pattern may be repeated in subsequent chirped frames. In some embodiments, the predefined chirp pattern may include: a sawtooth pattern, a triangle-wave pattern or a trapezoidal pattern. A triangle-wave pattern may allow the contributions in the received signals associated with relative position and velocity to be separated or disambiguated. Note that the relative position and velocity in the received signals may be measured by beating the received signals with a transmit (or chirp) signal, which may result in a beat frequency that is proportional to: the time delay of the received signals and a slope of the carrier frequency as a function of time; and the Doppler effect caused by the relative velocity difference between the sensor and the target for the wavelength used in the measurements.

Using processing circuit 100, the received signals (such as reflected signals) in the lidar measurements and/or the radar measurements may be conditioned prior to peak detection in order to mitigate interference sources (such as frequency-modulated radio, electromagnetic interference from a circuit board that includes an integrated circuit with processing circuit 100, intentional jammers, bumper or housing reflections, etc.) and/or may homogenize background noise. This processing may improve or optimize the peak detection, which may result in an improved probability of detection, a reduced probability of false alarms, and/or a precision.

As shown in FIG. 1, processing circuit 100 may include several stages that can be used, bypassed, and/or reordered.

A first stage in processing circuit 100 may include a trackable interference estimator. This stage or block may be useful for interference sources that are trackable or predictable. For example, the magnitude and phase of an interference source may be estimated with reasonable accuracy. In some embodiments, the interference source may include: a bumper or housing reflection, another parasitic reflection in the optical domain, and/or radio-frequency interference (RFI) associated with a synchronous clock in an integrated circuit that includes processing circuit 100 and/or in a circuit board that includes the integrated circuit and one or more interleaved analog-to-digital conversion (ADC) spurs.

The trackable interference estimator may receive a complex output of an FFT. Then, based at least in part on monitoring of the statistics of each FFT bin, the trackable interference estimator may decide which bins to track. In some embodiments, the bins to be tracked can be automatically selected by the trackable interference estimator or they may be indicated directly by the user. For example, the trackable interference estimator may determine which bins to track on its own, based at least in part on pre-programmed logic or using one or more other techniques, or the trackable interference estimator may determine bins based at least in part on a user input, such as a user input that provides bin information to the trackable interference estimator. For each of these bins, the trackable interference estimator may track the complex value and may make an estimate of the complex value for the next FFT (such as the FFT of the received signals associated with the next predefined chirp pattern or the next chirped frame). This estimation may be subtracted from the FFT of the received signals on a bin-by-bin basis. Note that the level of mitigation may be limited by the quality of the estimation.

A second stage in processing circuit 100 may include an equalization vector estimator. This stage or block may be useful for interference sources whose magnitude and/or phase are not trackable. However, the magnitude may be reasonably stable in frequency. Examples include: a frequency-modulated radio station, interference associated with the Institute of Electrical and Electronics Engineers (IEEE) 802.11 (which is sometimes referred to as Wi-Fi), radar, and/or other sources of electromagnetic interference that are stable in a given frequency band or band of frequencies.

The equalization vector estimator may receive the magnitude squared, logarithm of magnitude or amplitude of the FFT of the received signal. Then, based at least in part on this FFT and monitoring of the statistics of each bin, the equalization vector estimator may calculate an equalization array that will flatten the noise profile (such as across the bins). For example, the average energy across or over the bins may be constant. Alternatively or additionally, when a measurement device that outputs transmit signals is pointing at the sky (and, thus, when there are no return or received signals), the noise profile may be flat (or may have a horizontal or zero slope as a function of frequency or across the bins). Note that the equalization vector estimator may use statistics of the received signals in order to calculate the equalization vector when ‘sky measurements’ are not available. In some embodiments, the output of the equalization vector estimator may be an equalization vector that may be multiplied point-by-point (or bin-by-bin) with the input received signals. The complex vector times real vector operation and magnitude squared, logarithm of magnitude or amplitude calculations may be swapped in order to trade off the computational complexity and performance.

In some embodiments, the equalization performed by the equalization vector estimator is based at least in part on a target criterion. For example, the target criterion may include: a constant average energy in the frequency domain (such as across the bins); a constant moment of a distribution (such as a median) of a magnitude square, logarithm of magnitude or amplitude in the frequency domain (such as across the bins); or a boosting of the magnitude square, logarithm of magnitude or amplitude at frequencies greater than a predefined value (such as frequencies or bins corresponding to a largest range from processing circuit 100). Moreover, the target criterion may be based at least in part on a performance metric associated with peak detection in the received signals. Alternatively or additionally, the target criterion may ensure a noise profile associated with the received signals has a desired (e.g., a predefined or predetermined) shape when the received signals correspond to an absence of returned signals during the measurements (such as the so-called ‘sky measurements’).

A summation in processing circuit 100 may perform non-coherent integration of multiple acquisitions (as indicated by the ‘A’ block 112 in FIG. 1). This can be across de-speckling channels, from different modes, from different times, different polarizations, etc. Thus, the summation may combine received signals associated with different measurements. For example, the different measurements may use electromagnetic transmit signals: in different channels or bands of frequencies and/or having different polarizations (such as to de-speckle the different measurements). In some embodiments, the summation may combine the magnitude square, the magnitude, or a logarithm of magnitude of the different measurements.

A CFAR noise estimator in processing circuit 100 may implement a CFAR estimation technique (such as cell-averaging CFAR or CA-CFAR, ordered-statistics CFAR or OS-CFAR, greatest-of-CFAR or GOF-CFAR, etc.). The CFAR noise estimate may estimate the noise at each FFT bin based at least in part on the information from its neighbors (or neighboring bins).

Moreover, an alpha array estimator in processing circuit 100 may use the CFAR estimation technique to calculate an estimation of the noise, which is then multiplied by a scalar to adjust the probability of false-alarm detection. The alpha array estimator may calculate an array (instead of a scalar) with which the probability of false alarm and probability of detection may be adjusted bin-by-bin. Thus, the product with the alpha array may provide a threshold that the FFT of the received signals is compared to in order to detect the one or more peaks (such as a peak at 92.7 MHZ). In some embodiments, the amplitude of the received signals may need to be 3-15× the estimated noise level to be considered a candidate for peak detection.

Note that the input to the alpha array estimator may be: the equalization vector to compensate for the effect of blanking bins of the FFT; and/or the information from the false alarm detector, so that a detection threshold for a bin producing a large number of false alarms increases as a function of time.

Furthermore, processing circuit 100 may include a local maximum finder in order to add an extra constraint to the detected peaks. For example, in order to be considered a peak, an amplitude of a bin may need to be a local maximum and the amplitude may exceed a CFAR threshold. More generally, the one or more peaks may be detected: using a local maximum detector; based at least in part on a number of the one or more peaks; and/or based at least in part on a comparison with the CFAR threshold.

Additionally, processing circuit 100 may include an unfindable peaks block. This block may be a mask that may be used to mark one or more FFT bins as unfindable. This may be a mitigation strategy for bins that have statistical properties that make the other mitigation strategies (such as the trackable interferences, the equalization vector and the alpha array) less effective or ineffective. The unfindable peaks estimator may receive input from the false alarm detector and may decide whether to make some FFT bins unfindable. For example, because of the narrow widths in lidar measurements, the FFT of received signals in a scanning system for or corresponding to adjacent chirped frames may correspond to the same or nearby points in space. When a sudden change in the relative position and/or velocity is found (relative to the results of neighboring chirped frames), these measurements may be deemed off-pattern and, when their corresponding FFT bins are frequent false alarms and neither the first stage or the second stage are able to properly mitigate the false alarms, the corresponding bins in the FFT of the received signals may be blocked.

Note that, when detecting the one or more peaks, processing circuit 100 may reverse an equalization correction performed by the equalization vector estimator (e.g., in the magnitude correction) in order to obtain a true energy of the received signals.

In some embodiments, the different estimator blocks may be used for blockage detection, weather detection, intentional jamming detection, etc. This is because these blocks may calculate different statistical metrics of the received signals. For example, when the equalization vector estimation finds a much higher standard deviation in the low frequency bins compared to the high frequency bins, it may indicate bad weather conditions. Moreover, a standard deviation below a predefined value on all frequencies above the bumper reflection may indicate a blockage of transmit signals and/or receive signals.

As previously mentioned, in some examples of the present system, peak detection may be performed without using CFAR to obtain the comparison threshold. However, the third stage may perform peak detection by establishing a fixed comparison threshold and omitting the use of CFAR (such as with lidar measurements). The fixed comparison threshold may be used by the alpha array to establish a threshold detection level. Using a fixed comparison threshold may enable the system to perform better and reduce the overall computational costs. The improved performance and reduction in computation cost may be due to the use of the equalization vector and/or the omission of CFAR. This approach may allow the determination of where the noise is located and, therefore, can be used to establish the fixed comparison threshold to achieve a certain probability of false alarm and detection.

Note that the equalization vector, findable peaks, interference estimation and/or alpha array may be tracked individually per channel and/or per slope in the chirp frame.

In some embodiments, the radar measurements may include thousands of chirps or chirp frames. However, the Doppler effect may be smaller than in lidar measurements. The lidar measurements may use a carrier frequency of approximately 200 THz. In the lidar measurements, the Doppler effect may be much larger than in the radar measurements and may be present in a single frame. Moreover, lidar measurements may be performed in microseconds, as opposed to milliseconds for radar measurements. Note that received signals for a frame may provide the beat frequency and, thus, the range to an object that reflects the radar and/or lidar transmit signals.

Because there is less scatter with lidar, measurement points may correspond to millidegrees. In addition, the clutter may be reduced in lidar measurements relative to radar measurements. In fact, lidar measurements may be used to track clutter across multiple frames, so that the integrated circuit can dynamically adjust or adapt to the clutter. In some embodiments, the short-chirped frames in lidar measurements may allow the tracking of a true target or object in an environment, as well as atmospheric conditions. Note that the processing performed by processing circuit 100 may be performed on the received signals associated with each chirp or chirped frame.

Note that the numerical values listed in FIG. 1 are illustrative examples. In other embodiments, different numerical values may be used. Moreover, the processing circuit in FIG. 1 may include fewer or additional components, two or more components may be combined into a single component, a single component may be implemented using two or more separate components, and/or a position of one or more components may be changed.

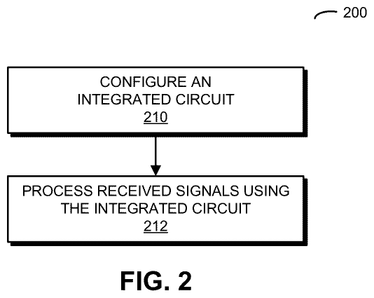

We now describe embodiments of a method. FIG. 2 presents a flow diagram illustrating an example of a method 200 for selectively performing processing of received signals using an integrated circuit, such as integrated circuit 100 (FIG. 1). During operation, a control circuit in the integrated circuit may configure the integrated circuit (operation 210) to use one or more stages in the integrated circuit. Then, the integrated circuit may process received signals (operation 212) using the one or more stages.

In some embodiments of method 200, there may be additional or fewer operations. Moreover, the order of the operations may be changed, and/or two or more operations may be combined into a single operation.

The disclosed integrated circuit and the circuit techniques can be (or can be included in) any electronic device or system. For example, the electronic device may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, a vehicle, a ship, an airplane, a car, a truck, a bus, a motorcycle, manufacturing equipment, farm equipment, construction equipment, or another type of electronic device.

Although specific components are used to describe the embodiments of the integrated circuit, in alternative embodiments different components and/or subsystems may be present in the integrated circuit. Thus, the embodiments of the integrated circuit may include fewer components, additional components, different components, two or more components may be combined into a single component, a single component may be separated into two or more components, one or more positions of one or more components may be changed, and/or there may be different types of components.

Moreover, the circuits and components in the embodiments of the integrated circuit may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar. Note that electrical coupling or connections in the preceding embodiments may be direct or indirect. In the preceding embodiments, a single line corresponding to a route may indicate one or more single lines or routes.

As noted previously, an integrated circuit may implement some or all of the functionality of the circuit techniques. This integrated circuit may include hardware and/or software mechanisms that are used for implementing functionality associated with the circuit techniques.

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the circuit techniques may be implemented using program instructions that are executed by a processor or in firmware in an integrated circuit.

Moreover, while examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An integrated circuit, comprising
multiple stages; and
a control circuit configured to configure the use of one or more of the stages, wherein, at a given time, the integrated circuit is configured to use one or more of the stages in processing of received signals associated with measurements in an environment, and wherein:
a first stage in the stages is configured to perform coherent interference mitigation by correcting the received signals for a predicted complex signal associated with a spurious source;
a second stage in the stages is configured to perform equalization of the received signals based at least in part on a target criterion; and
a third stage in the stages is configured to combine different received signals and detect one or more peaks in the received signals.

2. The integrated circuit of claim 1, wherein the different received signals correspond to different measurements in the measurements.

3. The integrated circuit of claim 1, wherein the predicted complex signal comprises a predicted magnitude and a predicted phase associated with the spurious source over multiple frames in the measurements.

4. The integrated circuit of claim 1, wherein the measurements comprise: lidar measurements, radar measurements, or both.

5. The integrated circuit of claim 1, wherein correcting the received signals for the predicted complex signal is performed in a frequency domain.

6. The integrated circuit of claim 1, wherein the spurious signal is associated with a reflection from a window or a housing.

7. The integrated circuit of claim 1, wherein the equalization is performed in a frequency domain.

8. The integrated circuit of claim 1, wherein the target criterion comprises: a constant average energy in a frequency domain; a constant moment of a distribution of a magnitude square amplitude in the frequency domain; or a boosting of the magnitude square amplitude at frequencies greater than a predefined value.

9. The integrated circuit of claim 1, wherein the target criterion is based at least in part on a performance metric associated with peak detection.

10. The integrated circuit of claim 1, wherein the target criterion is that a noise profile associated with the received signals has a predefined or predetermined shape when the received signals correspond to an absence of returned signals during the measurements.

11. The integrated circuit of claim 1, wherein the received signals correspond to optical signals having carrier frequencies that vary as a function of time using a predefined function.

12. The integrated circuit of claim 1, wherein an order of the stages in the integrated circuit is configurable.

13. The integrated circuit of claim 1, wherein the integrated circuit comprises a transformation circuit configured to perform a Fourier Transform of the received signals before the multiple stages.

14. The integrated circuit of claim 1, wherein the integrated circuit is configured to perform operations performed by the integrated circuit in hardware, software, or both.

15. The integrated circuit of claim 1, wherein the stages in the integrated circuit are configured to operate independently of each other.

16. The integrated circuit of claim 1, wherein the third stage is configured to combine a magnitude square of the different measurements in a frequency domain; and
wherein the different measurements use electromagnetic transmit signals: in different channels or bands of frequencies, having different polarizations, or both.

17. The integrated circuit of claim 1, wherein the third stage is configured to detect the one or more peaks in the received signals using a constant false alarm rate (CFAR) estimation technique; and
wherein the CFAR estimation technique comprises one or more of: determining a threshold corresponding to a noise level in a frequency domain; detecting the one or more peaks in the received signals based at least in part on a detection probability and a false-alarm rate; or
estimating false alarms in the one or more peaks in the received signals.

18. The integrated circuit of claim 1, wherein the third stage is configured to detect the one or more peaks in the received signals based on a fixed comparison threshold.

19. The integrated circuit of claim 1, wherein the one or more peaks are detected: using a local maximum detector; based at least in part on a number of the one or more peaks; or based at least in part on a comparison with a threshold determined using a constant false alarm rate (CFAR) estimation technique.

20. The integrated circuit of claim 1, wherein the third stage is configured to block detection of a set of blocked out peaks in the received signals.

21. The integrated circuit of claim 1, wherein at least some of the operations in the multiple stages may be repeated for the different received signals; and
wherein the different received signals correspond to different electromagnetic transmit signals: in different channels or bands of frequencies, having different polarizations, or both.

22. The integrated circuit of claim 1, wherein the third stage is configured to reverse an equalization correction performed by the second stage.

23. A method for selectively performing processing of received signals, comprising:
by an integrated circuit:
configuring use of one or more of multiple stages in the integrated circuit, wherein, at a given time, the integrated circuit uses one or more of the stages in the processing of the received signals associated with measurements in an environment; and
processing the receive signals, wherein during the processing:
a first stage in the stages performs coherent interference mitigation by correcting the received signals for a predicted complex signal associated with a spurious source;
a second stage in the stages performs equalization of the received signals based at least in part on a target criterion; and
a third stage in the stages combines different received signals and detects one or more peaks in the received signals.

24. A system, comprising:
an integrated circuit, wherein the integrated circuit comprises:
multiple stages; and
a control circuit configured to configure the use of one or more of the stages, wherein, at a given time, the integrated circuit is configured to use one or more of the stages in processing of received signals associated with measurements in an environment, and wherein:
a first stage in the stages is configured to perform coherent interference mitigation by correcting the received signals for a predicted complex signal associated with a spurious source;
a second stage in the stages is configured to perform equalization of the received signals based at least in part on a target criterion; and
a third stage in the stages is configured to combine different received signals and detect one or more peaks in the received signals.
